(19) United States
(12) Patent Application Publication
(10) Pub. No.: US 2019/0104361 A1
(43) Pub. Date: Apr. 4, 2019

(54) EFFECTS DEVICE FOR USE WITH AUDIO SOURCES

(71) Applicant: Matthew Alexander ABEL, Baton Rouge, LA (US)

(72) Inventor: Matthew Alexander ABEL, Baton Rouge, LA (US)

(21) Appl. No.: 15/725,076

(22) Filed: Oct. 4, 2017

(51) Int. Cl. H04R 3/02; H04B 1/06; H04R 23/00; G10H 1/02

(52) U.S. Cl. CPC H04R 3/02; H04B 1/06; H04R 2420/07; G10H 1/02; H04R 23/004

(57) ABSTRACT

An improved effects device for use with audio sources is provided. The improved effects device includes a plasma speaker that receives an original electrical signal and emits both sound waves and a radio frequency signal derivative of the original electrical signal. The improved effects device also includes a radio receiver configured to receive the radio frequency signal and convert it into an electrical signal. The electrical signal may then be amplified and used to drive a conventional loudspeaker. Advantageously, the new electrical signal is altered from the original electrical signal. The improved effects device may also include a low gain amplifier that receives the original electrical signal from an audio source, like an electric guitar, and amplifies the original electrical signal before transmitting it to the plasma speaker.

### BACKGROUND

The field of the present disclosure generally relates to effects devices for musical sources.

Effects units are often used in connection with musical instruments or other sources of audio sounds. When activated, an effects unit alters the sounds associated with a musical instrument or other audio source. Effects units are commonly used with electrical guitars and other electrical instruments, like keyboards or electric bass. They may also be used with acoustic instruments or other sources of audio sounds, such as with disc jockey devices or other sources of recorded music or sound.

Existing effects units use various techniques to generate the desired effect. Some effects units have analog circuitry, relying on various mechanical or electrical components to generate the desired effect. The use of vacuum tubes or transistors are examples of analog effects units. Other effects units employ digital circuitry. Digital effects units may employ signal processing techniques to generate the desired effect, and in some cases, these units are intended to mimic the effects of an analog unit. Effects units may also employ both analog and digital circuitry.

A common example of an effects unit is the “fuzz pedal.” These units are ordinarily plugged in line with an electric guitar's connection to an amplifier and loudspeaker. That is, the output of the electric guitar is plugged into the input of the fuzz pedal, and the output of the fuzz pedal is plugged into the input of the amplifier. Frequently, an electric guitar amp has an integrated loudspeaker. The fuzz pedal is ordinarily placed on the floor so that it can be manipulated by the guitarist's feet. The fuzz pedal may include one or more switches that control whether and which effects are applied to the audio signal. Numerous other effects units are also well known.

Effects units produce numerous types of effects. Non-limiting examples of effects include distortion, dynamics, filter, modulation, and feedback effects. Certain effects are desirable for different reasons depending on the type of instrument and musical performance. Frequently, the desired effects alter sounds in such a way that a user could not reproduce the sound with the instrument alone.

Notwithstanding the variety of known effects units, short comings exist in current effects units. Effects units are ordinarily hard-wired devices, meaning that the musical device is connected via a hard wire to the effects unit, which is connected through another hard wire to an amplifier. The requirement of a wired connection from end to end limits the available configurations.

Current effects units also do not generate any audio-visual effects, and most do not even generate any sounds of their own. Instead, effects units ordinarily receive the electrical signal from the guitar or other musical instrument, modify the signal by imposing their effect, and transmit the modified electrical signal to an amplifier by a hard-wired connection. The amplifier in turn amplifies the signal and passes it to a loudspeaker, at which point a listener may perceive the effects of the effects unit.

Many effects units also do not include features that prevent audio feedback. The term audio feedback describes feedback loops that occur when an audio input picks up the signals generated by an audio output. Thus, in many applications, users must employ additional devices (beyond the effects unit) to address concerns of audio feedback.

Consequently, there exists a need in the art for an effects unit that is wireless, that may generate audio or audio-visual effects own its own, and that may address issues of audio feedback.

### SUMMARY

The present disclosure describes an improved effects device for use with audio sources. The improved effects device is intended to be used with various types of audio sources, and in particular with electric guitars and other electric instruments. It is envisioned that the improved effects device will be advantageous for its unique audio-visual effects and wireless capabilities. Embodiments of the invention described herein may satisfy one or more, but not necessarily all, of these needs or capabilities.

In a first aspect, an improved effects device is provided comprising at least one plasma speaker that receives an original electrical signal and emits a radio frequency signal derivative of said original electrical signal; and a radio receiver configured to receive the radio frequency signal and to convert the radio frequency signal into a second electrical signal. Optionally, the improved effects device may include a low gain amplifier for receiving the original electrical signal, amplifying the original signal, and transmitting the amplified original signal to the at least one plasma speaker.

In a second aspect, a system for imposing effects on sounds is provided comprising an audio source for generating an original electrical signal; an improved effects device including (i) at least one plasma speaker that receives the original signal and emits a radio frequency signal derivative of the original signal; and (ii) a radio receiver configured to receive the radio frequency signal and to convert the radio frequency signal to a second electrical signal; a high gain amplifier for receiving and amplifying the second electrical signal; and a loudspeaker driven by the amplified second signal.

In a third aspect, a method for imposing an effect on an audio signal is provided, the method comprising generating an original electrical signal; transmitting the original signal to a low gain amplifier; amplifying the original signal at the low gain amplifier; driving at least one plasma speaker with the amplified original signal, wherein the at least one plasma speaker emits a radio frequency signal derivative of the original signal; receiving the radio frequency signal by a radio receiver; and converting the radio frequency signal to a second electrical signal.

The above summary presents a simplified summary to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

### BRIEF DESCRIPTION OF DRAWINGS

FIG. 1: A diagram showing an embodiment of the improved effects device in use with an electric guitar.

FIG. 2: A schematic diagram showing a system using an embodiment of the improved effects device that includes a low gain amplifier and a switching device.

### DEFINITIONS

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural forms as well, unless the context clearly indicates otherwise.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

The term “consisting essentially of” means that, in addition to the recited elements, what is claimed may also contain other elements (steps, structures, ingredients, components, etc.) that do not adversely affect the operability of what is claimed for its intended purpose as stated in this disclosure. This term excludes such other elements that adversely affect the operability of what is claimed for its intended purpose as stated in this disclosure, even if such other elements might enhance the operability of what is claimed for some other purpose.

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The following description illustrates and describes the processes, machines, manufactures, compositions of matter, and other teachings of the present disclosure. Additionally, the disclosure shows and describes only certain embodiments of the processes, machines, manufactures, compositions of matter, and other teachings disclosed, but, as mentioned above, it is to be understood that the teachings of the present disclosure are capable of use in various other combinations, modifications, and environments and is capable of changes or modifications within the scope of the teachings as expressed herein, commensurate with the skill and/or knowledge of a person having ordinary skill in the relevant art. The embodiments described hereinabove are further intended to explain certain best modes known of practicing the processes, machines, manufactures, compositions of matter, and other teachings of the present disclosure and to enable others skilled in the art to utilize the teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein. Any section headings herein are provided only for consistency with the suggestions of 37 C.F.R. § 1.77 or otherwise to provide organizational cues. These headings shall not limit or characterize the invention(s) set forth herein.

### DETAILED DESCRIPTION

An improved effects device for use with audio sources has been developed. For ease of understanding, this disclosure generally describes the use of the effects device in connection with an electrical guitar and a loudspeaker. But as one of ordinary skill in the art will understand, the effects device taught in this disclosure may be advantageously employed in many types of musical or audio systems. For instance, the effects device may be employed with other types of electronic instruments, such as a keyboard, or with acoustic instruments. Additionally, the effects device may be employed in connection with other audio sources, such as a digital audio player (i.e. a portable MP3 player). In some embodiment, disc jockeys may use one or more of the effects units. The effects device may be advantageous in both live performances and recording studios. Any of the foregoing uses are within the scope of this disclosure.

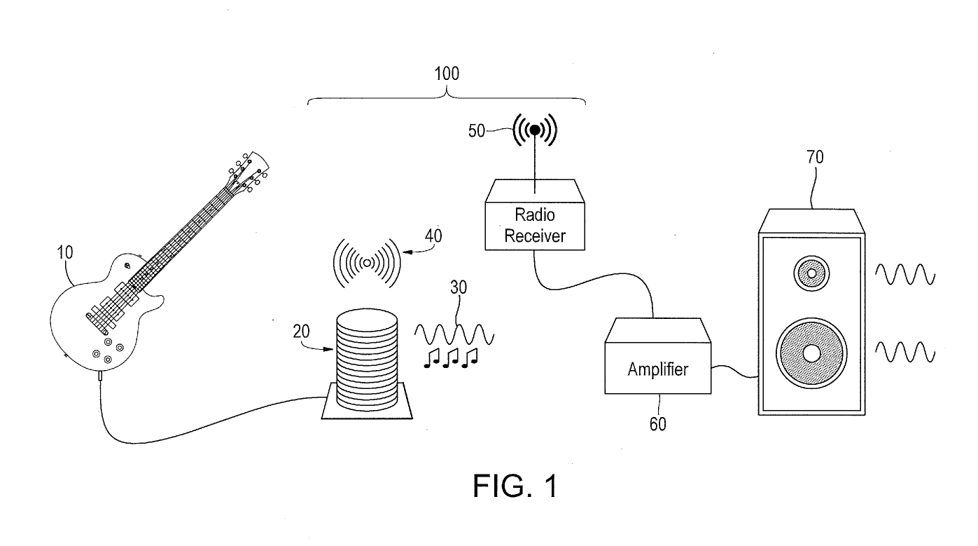

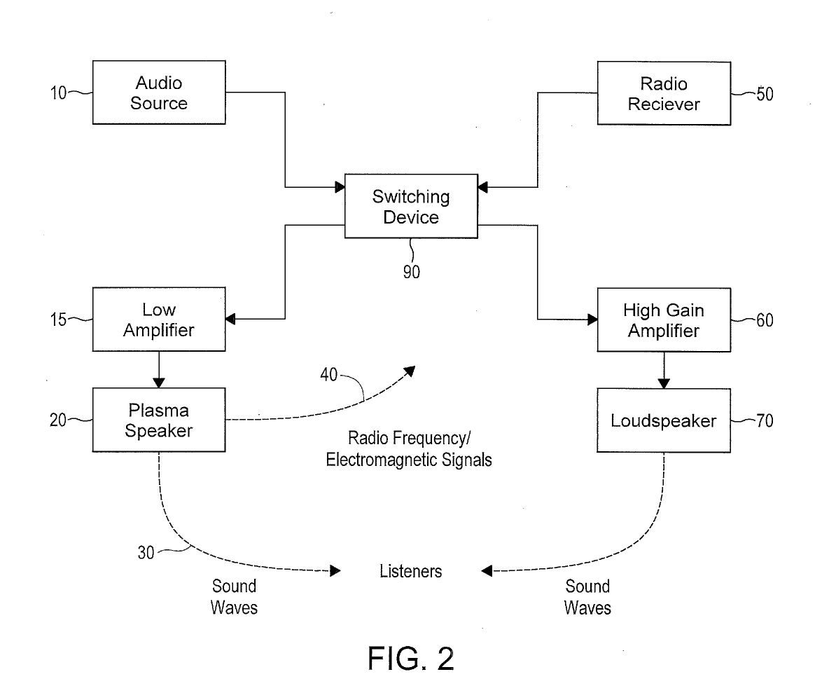

FIG. 1 shows one example of a system including an exemplary embodiment of the improved effects unit. In this embodiment, the system comprises an electric guitar 10, that is electrically connected to the exemplary embodiment of the improved effects device 100, which is connected to a conventional high gain amplifier 60 and loudspeaker 70. As shown, the exemplary embodiment of the improved effects device 100 includes a plasma speaker 20 and a radio receiver 50. Optionally, as shown in the embodiment of FIG. 2, the improved effects device 100 may also include a low gain amplifier 15. The low gain amplifier (or the plasma speaker as the case may be) is electrically connected to the audio output of the electric guitar 10 to receive the electrical signal when a user plays the guitar 10. The output of an electric guitar is ordinarily an analog signal. The low gain amplifier 15 (if present) is in turn electrically connected to the input of the plasma speaker 20. When the plasma speaker 20 receives the amplified electrical signal, the plasma speaker 20 emits sound waves and a radio frequency signal 40 that are derived from the amplified electrical signal from the guitar. The radio receiver 50 includes an antenna configured to receive the radio frequency signal 40. The receiver 50 then converts the radio frequency signal into an electrical signal and transmits the electrical signal to the high gain amplifier 60. The amplifier 60 amplifies the electrical signal to drive the loudspeaker 70.

The components of the improved effects device 100 are now described in further detail. In many embodiments, the improved effects device 100 includes a low gain amplifier 15. Because most electric guitars (or other electric instruments) generate an electrical signal having low power, the low gain amplifier 15 is used to amplify the electrical signal sufficient to drive the plasma speaker 20. In some embodiments, the low gain amplifier 15 has a wattage of approximately 5 watts. An example of a suitable low gain amplifier 15 is sold under the name Hotone Mojo Diamond. The power output of the low gain amplifier 15 may be variable, and may also be selected at a level sufficient to overdrive the plasma speaker. In other embodiments, however, the improved effects device 100 may not include a low gain amplifier 15. For instance, a low gain amplifier 15 may be unnecessary when used with a musical instrument or another audio source (i.e. disc jockey equipment) that generates sufficient power to drive the plasma speaker 20.

The improved effects device 100 includes at least one plasma speaker 20. As used herein, plasma speaker 20 refers to speakers that generate sound by varying an electrical plasma instead of a solid diaphragm. Numerous plasma speakers 20 are commercially available. In some embodiments of the improved effects device 100, the plasma speaker is a Sunnytech Super Mini Tesla Loudspeaker “M072.” Although the disclosure herein generally discusses the use of one plasma speaker 20, it is to be understood that multiple plasma speakers may be employed within the scope of this invention. Multiple plasma speakers may be desirable where there are multiple instruments or where multiple effects are desired.

When driven by an electrical signal, the plasma speaker 20 produces two responses to the electrical signal. First, the plasma speaker 20 causes mechanical vibrations 30 in the surrounding air that are received as sound waves by the human auditory spectrum. How plasma speakers generate sound waves is well-understood by persons of ordinary skill in the art and not required to understand the invention of this disclosure. But in general terms, the plasma speaker 20 generates a plasma by ionizing the air surrounding it. In response to an electrical signal, the plasma speaker 20 varies the plasma. Those variations cause the air pressure surrounding the plasma to vary and, thereby, create compression waves (i.e. vibrations) that listeners perceive as sound. Advantageously, the sound produced by the plasma speaker 20 may be distinct from the sound produced by conventional loudspeakers (i.e. those with solid diaphragms). For example, in some embodiments the sounds produced by the plasma speaker 20 have a much more fuzzy effect, especially when overdriven. The distinct sounds generated by a plasma speaker 20 may be desirable during live and recorded performances. Additionally, in many embodiments, the variations of the plasma may be visually perceived by listeners. As a result, the plasma speaker 20 may produce an audio-visual effect that is derived from the electrical signal.

Second, the plasma speaker 20 produces electromagnetic disturbances 40 that generate a radio frequency (electromagnetic) signal derived from the electrical signal. The radio frequency signal is detectable by an antenna in the radio receiver, which converts the radio frequency signal back into an electrical signal. Although the new electrical signal is necessarily derived from the original electrical signal, it is not the same. The original electrical signal is altered when transmitted as a radio frequency signal by the plasma speaker 20. Advantageously, the alterations in the electrical signal, when turned into audio signals, may produce distortions or other types of effects that may be desirable for a particular instrument or performance. For instance, in some embodiments for use with an electric guitar, the radio frequency generated by the plasma speaker results in an electrical signal that generates audio sounds that are fuzzy.

The improved effects device 100 also includes a radio receiver 50. The radio receiver 50 includes an antenna that is tuned to the appropriate frequency so that it can receive the radio frequency signal and convert it into an electrical signal. Any suitable radio receiver 50 may be used if it includes an antenna that can be tuned to the appropriate frequency to receive the radio frequency signal. In some embodiments, the radio receiver 50 is a crystal radio receiver. A crystal radio receiver is well known in the art and generally includes an antenna, a tuned circuit, and a detector. The tuned circuit is connected to the antenna and allows the user to select the appropriate frequency for detecting the radio frequency signal. The tuned circuit ordinarily consists of a coil of wire (called an inductor) and a capacitor. In some devices, the inductor is circumferentially wound copper wire. The resulting tuned circuit has a resonate frequency, which may be changed by adjusting the properties of the inductor or capacitor. For instance, more or fewer coils will change the resonate frequency of the circuit. The signals detected at the resonate frequency are the only ones passed to the detector; all others are filtered out. The detector, which may be a semiconductor crystal, demodulates the radio frequency signal into an electrical signal. Advantageously, a crystal radio receiver does not require any external power source. Of course, other types of radio receivers 50 with appropriate antennas may also be used. Dipole, patch, slot, helical, and microstrip antennas, and variants thereof, as well as any other antenna design known in the art, may be used.

As shown in FIG. 1, the radio receiver 50 transmits the electrical signal to a high gain amplifier 60. The amplifier 60 amplifies the electrical signal to an appropriate wattage so that the signal can drive the loudspeaker 70. The loudspeaker 70 may be any type of loudspeaker typically used with electrical instruments. In some embodiments, such as those used with electric guitars, the amplifier 60 and the loudspeaker 70 are integrated into one unit (i.e. a standard electric guitar amplifier). An example of such a unit is sold under the name Silver Tone Twin 12. Alternatively, the amplifier 60 and loudspeaker 70 may be standalone.

In some embodiments, a different device may receive the electrical signal from the radio receiver 50. For instance, when the improved effects device 100 is used in a recording studio, an audio interface may receive the electrical signal. The electrical signal may then be processed or stored as desired.

Embodiments of the improved effects device 100 have numerous additional advantages. One advantage is that the improved effects device 100 is wireless because the plasma speaker 20 transmits the signal via radio frequency signals to the radio receiver 50. Thus, the plasma speaker 20 and the radio receiver 50 may be physically separated. So long as the plasma speaker 20 transmits at a sufficient power level and/or the antenna of the radio receiver 50 has sufficient sensitivity to detect the radio frequency signal, a user may select any appropriate location for the plasma speaker 20 and the radio receiver 50.

Another advantage of the improved effects device 100 is that it may help prevent audio feedback. In systems employing an embodiment of the improved effects device 100, audio feedback is significantly reduced or virtually eliminated because the electrical signals must pass through at least one improved effects device 100. This is true even when the audio source 10 is placed in very close proximity to the loudspeaker 70.

In some embodiments, the improved effects device 100 also includes or is connected to a switching device 90. FIG. 2 shows an example of an embodiment with a switching device 90. Advantageously, the switching device 90 may be a foot pedal or other foot-operated device. A foot-operated switch has the advantage that a user may continue to play the instrument with their hands while also controlling the switch 90. Other types of switching devices 90 may be used as well.

The switching device 90 may allow a user to select a plurality of states in which to operate the system. The possible states include any combination of the following states. In a first state, the switching device 90 causes the system to bypass the improved effects device 100. In other words, the electrical signal is transmitted directly from the guitar 10 to the high gain amplifier 60 and loudspeaker 70. As will be obvious to one of ordinary skill, the system may also include many other types of effects units. So in this first state, the signal may optionally be transmitted to other effects units, which may be controlled by other switches.

In a second state, the switching device 90 causes the electrical signal to pass through the improved effects device 100. When the system is in this state, the electrical signal passes through the low gain amplifier 15 (if present) and to the plasma speaker 20. The radio receiver 50 then receives the radio frequency signal emitted by the plasma speaker 20 and converts the signal into a new electrical signal. That new signal can drive a loudspeaker 70. In this second state, both the plasma speaker 20 and the loudspeaker 70 generate audible sounds that are derived from the original electrical signal.

In a third state, the switching device 90 causes the electrical signal to be transmitted to the plasma speaker 20 but not to the loudspeaker 70. The switch 90 may accomplish this state by disabling the radio receiver 50, the high gain amplifier 60, and/or the loudspeaker 70. As a result, the system generates audible sounds through only the plasma speaker 20.

In some embodiments, the system may include two or more improved effects units 100. Where a system has two improved effects devices 100, the switching device 90 may have a fourth state that causes only the first improved effects device 100 to operate. The switching device 90 may also have a fifth state that causes only the second improved effects device 100 to operate. In embodiments with three or more improved effects devices 100, the switching device 90 may have a plurality of states to selectively operate only a subset of the improve effects devices 100.

While the invention has been described with respect to a limited number of embodiments, those skilled in the art, having benefit of this disclosure, will appreciate that other embodiments can be devised which do not depart from the scope of the invention as disclosed here.

1. A device for imposing an effect on an audio signal, said device comprising:
a. at least one plasma speaker, wherein said at least one plasma speaker receives an original electrical signal and emits a radio frequency signal derivative of said original electrical signal; and
b. a radio receiver configured to receive said radio frequency signal and to convert said radio frequency signal to a second electrical signal.

2. The device of claim 1 further comprising: a low gain amplifier for receiving said original electrical signal from an audio source, amplifying said original electrical signal, and transmitting said original electrical signal to said at least one plasma speaker.

3. The device of claim 2, wherein the low gain amplifier has a wattage of less than about 5 watts.

4. The device of claim 1, wherein said original electrical signal is an analog signal.

5. The device of claim 4, wherein the analog signal is a signal produced by an electric guitar.

6. The device of claim 1, wherein said radio receiver is a crystal radio receiver.

7. The device of claim 1, the device further comprising a high gain amplifier for receiving said second electrical signal and driving a loudspeaker.

8. The device of claim 7, the device further comprising a switching device configured to switch between at least three states including:
(i) a first state wherein said original electrical signal, and not said second electrical signal, is transmitted to said loudspeaker;
(ii) a second state wherein said original electrical signal is transmitted to said plasma speaker; and
(iii) a third state wherein said original electrical signal is transmitted to said plasma speaker and said second electrical signal is transmitted to said loudspeaker.

9. A system for imposing effects on sounds, said system comprising:
a. an audio source for generating an original electrical signal;
b. an improved effects unit, the improved effects device comprising:
i. at least one plasma speaker, wherein said at least one plasma speaker receives said original electrical signal and emits a radio frequency signal derivative of said original electrical signal; and
ii. a radio receiver configured to receive said radio frequency signal and to convert said radio frequency signal to a second electrical signal;
c. a high gain amplifier for receiving and amplifying said second electrical signal; and
d. a loudspeaker driven by said second electrical signal.

10. The system of claim 9, the system further comprising:
a. a low gain amplifier for receiving said original electrical signal from said audio source, amplifying said original electrical signal, and transmitting said original electrical signal to said at least one plasma speaker; and
b. a switching device between said audio source and said at least one plasma speaker.

11. A method for imposing an effect on an audio signal, said method comprising:
c. receiving an original electrical signal by a low gain amplifier;
d. amplifying said original electrical signal at the low gain amplifier;
e. driving at least one plasma speaker with said original electrical signal after amplification, wherein said at least one plasma speaker emits a radio frequency signal derivative of said original electrical signal;
f. receiving said radio frequency signal by a radio receiver; and
g. converting said radio frequency signal to a second electrical signal.

12. The method of claim 11, wherein said original electrical signal is an analog signal.

13. The method of claim 11, wherein said original electrical signal is received from an electric guitar.

14. The method of claim 11 further comprising amplifying said second electrical signal and driving a loudspeaker with said amplified second electrical signal.

15. The method of claim 11, wherein said radio receiver is a crystal radio receiver.

16. A method for reducing feedback between an audio source and a loudspeaker, said method comprising:
h. connecting said audio source to the signal input of at least one plasma speaker, wherein said at least one plasma speaker emits a radio frequency signal derivative of a first electrical signal received by the signal input;
i. connecting said loudspeaker to the signal output of a radio receiver, wherein said radio receiver is configured to receive said radio frequency signal and to convert said radio frequency signal to a second electrical signal; and
j. transmitting an original electrical signal from said audio source to said loudspeaker via said at least one plasma speaker and said radio receiver.

17. The method of claim 16, further comprising:
k. connecting a low gain amplifier between said audio source and said at least one plasma speaker, wherein said low gain amplifier amplifies said original electrical signal; and
l. connecting a high gain amplifier between said radio receiver and said loudspeaker, wherein said high gain amplifier amplifies said second electrical signal.

18. The method of claim 16, wherein said original electrical signal is an analog signal.

19. The method of claim 16, wherein said radio receiver is a crystal radio receiver.

20. The method of claim 16, wherein the low gain amplifier has a wattage of less than about 5 watts.
